(19) United States
(12) Patent Application Publication
(10) Pub. No.: US 2014/0269146 A1
(43) Pub. Date: Sep. 18, 2014

(54) CONCRETE MIXING DRUM DRIVE SYSTEM

(71) Applicant: OSHKOSH CORPORATION, Oshkosh, WI (US)

(72) Inventors: Thomas J. Harris, Byron, MN (US); Clint Glunz, Oshkosh, WI (US)

(73) Assignee: OSHKOSH CORPORATION, Oshkosh, WI (US)

(21) Appl. No.: 13/835,645

(22) Filed: Mar. 15, 2013

(51) Int. Cl. B28C 5/42; B28C 5/08

(52) U.S. Cl. CPC B28C 5/4244; B28C 5/085
USPC 366/44

(57) ABSTRACT

A mixing drum system is disclosed. The mixing drum system includes a mixing drum connected to a frame, wherein the mixing drum is configured to rotate about a first axis with respect to the frame. The mixing drum system further includes a motor connected to the frame and having an output shaft, wherein the output shaft is configured to rotate about a second axis that is displaced from the first axis. The mixing drum system includes a first wheel connected to the output shaft of the motor, and a second wheel connected to the mixing drum. The mixing drum system includes a belt wrapped around the first wheel and the second wheel. The motor is configured to rotate the first wheel, which drives the belt, and the belt is configured to rotate the second wheel, which rotates the mixing drum with respect to the frame.

### BACKGROUND

The present application relates to a drive system for a drum of a concrete mixing truck. Concrete mixing drums may be mounted on a truck chassis. The mixing drums are configured to mix drum contents during transport and to dispense the drum contents through a chute. The chute may be located at the front (“front-discharge”) or the rear (“rear-discharge”) of the truck. In the case of a rear-discharge concrete mixing truck, the drum drive system sits between the truck's cab and the drum. The drum drive system includes a motor and a gearbox motor that are typically mounted to the rear of the drum. An exemplary mixing drum drive system of a concrete mixing truck is shown in U.S. Pat. No. 4,124,304 to Suganuma.

The motor and gearbox assembly of the drum drive system has many drawbacks. This arrangement of a drum drive system reduces the space available for other components of the concrete mixing truck, such as water storage tanks, exhaust systems, and front water injection systems. In order to make space for the additional required components, some concrete mixing trucks may end up having a longer envelope than what is necessary, which effects the workable cab to axle on the chassis. Additionally, the traditional motor and gearbox assembly may be expensive and heavy. For example, the gearbox may be constructed out of heavy casted iron and include an expensive gear assembly. Still further, because the motor and gearbox assembly is mounted to the end of the drum, maintenance or replacement of the drum and other systems (e.g., a front water injection system, the drum bearings, etc.) becomes an expensive and time consuming task as the motor and drum must first be removed from the concrete mixing truck.

### SUMMARY

One exemplary embodiment relates to a mixing drum system. The mixing drum system includes a mixing drum connected to a frame, wherein the mixing drum is configured to rotate about a first axis with respect to the frame. The mixing drum system further includes a motor connected to the frame and having an output shaft, wherein the output shaft is configured to rotate about a second axis that is displaced from the first axis. The mixing drum system includes a first wheel connected to the output shaft of the motor, wherein the first wheel is configured to rotate about the second axis, and a second wheel connected to the mixing drum, wherein the second wheel is configured to rotate about the first axis. The mixing drum system includes a belt wrapped around the first wheel and the second wheel. The motor is configured to rotate the first wheel, which drives the belt, and the belt is configured to rotate the second wheel, which rotates the mixing drum with respect to the frame.

Another exemplary embodiment of the invention relates to a concrete mixing truck. The concrete mixing truck includes a chassis. The concrete mixing truck further includes a cab connected to a front end of the chassis. The concrete mixing truck includes a mixing drum connected to the chassis, wherein the mixing drum is configured to rotate about a first axis with respect to the chassis. The concrete mixing truck includes a mixing drum drive system. The mixing drum drive system includes a motor connected to the chassis and having an output shaft, wherein the output shaft is configured to rotate about a second axis that is displaced from the first axis. The mixing drum drive system further includes a first wheel connected to the output shaft of the motor, wherein the first wheel is configured to rotate about the second axis, and a second wheel connected to the mixing drum, wherein the second wheel is configured to rotate about the first axis. The mixing drum drive system includes a belt wrapped around the first wheel and the second wheel. The motor is configured to rotate the first wheel, which drives the belt, and the belt is configured to rotate the second wheel, which rotates the mixing drum with respect to the chassis.

Yet another exemplary embodiment of the invention relates to a concrete mixing drum system. The concrete mixing drum system includes a mixing drum connected to a chassis. The mixing drum includes a drum spindle that defines a first axis and mixing fins. The mixing drum is configured to rotate about the first axis with respect to the chassis. The concrete mixing drum system further includes a motor connected to the chassis and having an output shaft. The output shaft is configured to rotate about a second axis that is offset and generally parallel to the first axis. The concrete mixing drum system includes a first wheel connected to the output shaft of the motor, wherein the first wheel is configured to rotate about the second axis. The concrete mixing drum system further includes a second wheel connected to the mixing drum, wherein the second wheel is configured to rotate about the first axis, and wherein the second wheel is mounted around the drum spindle. The concrete mixing drum system includes a belt wrapped around the first wheel and the second wheel, wherein the belt has belt traction elements. The motor is configured to rotate the first wheel, which drives the belt, and the belt is configured to rotate the second wheel, which rotates the mixing drum with respect to the chassis. The first wheel and the second wheel include wheel traction elements that correspond to the belt traction elements.

The invention is capable of other embodiments and of being carried out in various ways. Alternative exemplary embodiments relate to other features and combinations of features as may be recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a view of a concrete mixing truck according to an exemplary embodiment.

FIG. 2 is a view of a drum of a concrete mixing truck according to an exemplary embodiment.

FIG. 3 is a side view of a drum drive train of a concrete mixing truck according to an exemplary embodiment.

FIG. 4 is a side view of a drive wheel and belt according to an exemplary embodiment.

FIG. 5 is a cross-sectional view of a drum of a concrete mixing truck according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

According to the exemplary embodiments shown in FIGS. 1-5, a belt drive system for a mixing drum of a concrete mixing truck is shown. By providing the drive motor offset from the drum and utilizing a belt drive system for rotating the mixing drum, a more compact drum drive system is made possible. This more compact drum drive system reduces the length needed for drum placement on the truck. The shorter length allows for tighter mounting of the drum to the truck cab, room for water tanks, room for more robust and environmentally friendly truck exhaust systems, weight savings, greater drum articulation, easier drum and drive system maintenance relative to relative traditional concrete mixing trucks. Such a shorter length is accomplished while still providing a front water injection system. Further, belt drive systems offer advantages over chain drive systems including: producing less noise, reducing weight, requiring less maintenance, allowing for misalignment of the wheels, and allowing for articulation of the drum with respect to the motor.

Referring to FIG. 1, a concrete mixing truck 100 is shown according to an exemplary embodiment. Truck 100 is shown as a rear-discharge concrete mixing truck. Truck 100 includes chassis 102. Truck 100 includes cab 104, which is connected to chassis 102 at a front end of chassis 102. Truck 100 includes mixing drum 106, which is connected to chassis 102 behind cab 104 (e.g., at a rear and/or middle of chassis 102). Truck 100 includes mixing drum drive system 108 connected to chassis 102. Drum 106 is mounted to chassis 102 through front pedestal 110 and rear pedestal 112. Front and rear pedestals 110 and 112 secure drum to chassis 102 and allow for drum 106 rotation with respect to chassis 102. Mixing drum 106 is configured to rotate about axis 114. Axis 114 is angled with respect to chassis 102 such that axis 114 intersects with chassis 102. Axis 114 may be elevated from chassis in the range of five degrees to twenty degrees. In some arrangements, axis 114 is elevated by approximately twelve degrees. Drive system 108 is configured to rotate drum 106 about axis 114. Truck 100 includes chute 116 for dispensing the contents of drum 106 (e.g., concrete). Chute 116 receives contents exiting drum 106 and guides the received contents away from chassis 102 to the contents' destination (e.g., a concrete form, a wheelbarrow, a concrete pump machine, etc.). Truck 100 includes concrete hopper 118 for loading drum 106 with materials (e.g., concrete).

Referring to FIG. 2, drum 106 is shown according to an exemplary embodiment. Drive system 108 includes motor 202 and drive wheel 204. Drive wheel 204 may be a sprocket, a cogged wheel, a grooved wheel, a smooth-sided wheel, or still another member. Motor 202 is a hydraulic motor. Accordingly, truck 100 includes hydraulic reservoir 206 and a hydraulic pump (not shown), which power motor 202. Alternatively, motor 202 may be an internal combustion engine, an electric motor, or another suitable mechanical power source. Motor 202 is mounted to chassis 102 adjacent to front pedestal 110 such that motor is positioned in a manner that reduces the space needed to mount drum 106 and drive system 108 along the length of chassis 102 (as shown in FIG. 2 and FIG. 3). Accordingly, motor 202 is offset from axis 114. Motor 202 may be mounted at the same angle as drum 106 (i.e., such that the output spindle of motor 202 rotates about an axis parallel to axis 114). Motor 202 outputs a high torque and rotates at a low speed. Motor 202 may be configured to rotate at approximately 125 revolutions per minute. The rotational speed of motor 202 may be increased or decreased based on an operator input or a load sensor output that senses a status of the contents of drum 106. Motor 202 rotates drum 106 by rotating drive wheel 204 through a belt drive system (as shown and discussed below with respect to FIG. 3). Drive wheel 204 may be welded, bolted, or otherwise secured to the head of drum 106. The center of drive wheel 204 is along axis 114 such that drive wheel 204 rotates about axis 114.

Referring to FIG. 3, a side view of drive system 108 is shown according to an exemplary embodiment. Rotational motion generated by motor 202 is transferred to drive wheel 204 by a belt and wheel system. Motor 202 spins motor wheel 302. Motor wheel 302 may be a sprocket, a cogged wheel, a grooved wheel, a smooth-sided wheel, or still another member. Motor wheel 302 is mounted to an output shaft of motor 202. The output shaft is configured to rotate about an axis that is offset and generally parallel to axis 114. Motor wheel 302 drives belt 304. Belt 304 is wrapped around motor wheel 302 and drive wheel 204. Belt 304 spins drive wheel 204. Belt 304 may be a synchronous belt having a plurality of belt traction elements, shown as teeth 306. Teeth 306 may be standard linear teeth or helical offset teeth. Belt tensioner 308 includes roller 310 which provides force to belt 304 in order to maintain tension in belt 304 during use. Roller 310 may be spring loaded. Belt tensioner 308 may be mounted to motor 202, chassis 102, or front pedestal 110. In an alternative arrangement, motor 202 rotates drum 106 via a chain and sprocket drive system that is of a similar arrangement to the disclosed belt drive system (i.e., substituting motor wheel 302 and drive wheel 204 with sprockets suitable for a chain, and substituting belt 304 with a chain).

Referring to FIG. 4, a side view of motor wheel 302 is shown according to an exemplary embodiment. Motor wheel 302 includes a plurality of wheel traction elements, shown as teeth 402, that are configured to correspond with the belt traction elements. Teeth 402 are sized and shape to mesh with teeth 306 of belt 304. Accordingly, teeth 402 help prevent slipping of belt 304 and ensure efficient energy transfer from motor wheel 302 to belt 304. Motor wheel 302 additionally includes guide edges 406 (one on each side of motor wheel 302), which form a channel into which belt 304 is received. The channel may be a generally “U,” “C,” or “V” shaped. Belt 304 may have a cross-section that generally matches that of the channel formed by guide edges 406. Guide edges 406 help to prevent belt 304 from jumping off of motor wheel 302. Drive wheel 204 includes similar features as motor wheel 302. Drive wheel 204 includes wheel traction elements that correspond with the belt fraction elements (e.g., teeth that mesh with teeth 306). Guide edges formed within drive wheel 204 define a channel such that belt 304 maintains engagement with drive wheel 204.

Referring again to FIG. 3, motor wheel 302 has radius 312. Drive wheel 204 has radius 314. Radius 312 is smaller than radius 314. Thus, drive wheel 204 rotates at a slower speed than motor wheel 302. In some arrangements, radius 314 is approximately eight times larger than radius 312. Accordingly, drive system 108 is configured to rotate mixing drum 106 at a slower number of revolutions per minute than motor 202 is spinning

Still referring to FIG. 3, drum 106 is mounted to front pedestal 110 through drum spindle 316. Drum spindle 316 is received into trunion bearing 318. Drum spindle 316 is connected to drum 106. Drum spindle 316 is generally centered around axis 114. Trunion bearing 318 is mounted to front pedestal 110. Trunion bearing 318 provides vertical and lateral support to drum 106 while allowing generally free rotation of drum 106 about axis 114. Drive wheel 204 is mounted to drum 106 such that it is mounted around drum spindle 316 (e.g., encircles a circumference of drum spindle 316). Drive wheel 204 may be connected to drum spindle 316. Referring to FIG. 5, a cross-sectional view of drum 106 is shown according to an exemplary embodiment. Drum spindle 316 includes injection port 502. Injection port 502 is a hollow opening in drum spindle 316. Injection port 502 provides access into the interior of drum 106. Injection port 502 may be used for injection of water and/or chemicals (e.g., air entrainers, water reducers, set retarders, set accelerators, superplasticizers, corrosion inhibitors, coloring, corrosion inhibitors, calcium chloride, minerals, and other concrete admixtures) into the front of the interior of drum 106. Injection port 502 may include a valve (not shown) that allows water and/or chemicals to be pumped into drum 106 without allowing the contents of drum 106 to exit drum 106 through injection port 502. In an alternative arrangement, drum spindle 316 includes multiple injection ports (e.g., two injection ports, three injection ports) configured to independently inject different water and/or chemicals into drum 106. Drum 106 includes spiral fins 504. Spiral fins 504 mix the contents of drum 106 when drum 106 rotating in a first direction (e.g., counterclockwise). Spiral fins 504 push the contents of drum 106 out the top opening of drum 106 and onto chute 116 when drum 106 is rotating in a second direction (e.g., clockwise).

During operation, drum 106 is loaded with concrete through concrete hopper 118. Motor 202 rotates drum 106 in a first direction to mix and agitate the concrete contained in drum 106 with fins 504 to prevent the concrete from setting within drum 106. Water and/or chemicals may be pumped into drum 106 through injection port 502 to maintain the slump of the concrete and/or to prevent the concrete from setting within drum 106. When truck 100 reaches its destination and is ready to dispense the concrete, motor 202 is rotated in a second direction that is opposite the first direction. Fins 504 carry the concrete out of drum 106 and gravity pulls the concrete down chute 116 to the concretes destination (e.g., a concrete form, another concrete delivery machine, etc.).

Although truck 100 is drawn as a rear discharge concrete mixing truck, similar belt based drum drive trains may be applied to a front discharge concrete mixing truck. Additionally, drive system 108 may be used to drive a stand-alone mixing drum that is not attached to a truck chassis. In such an arrangement, the mixing drum and drive system may be mounted to a frame. The frame may be a chassis that includes wheels that assist with the positioning of the stand-alone mixing drum on a worksite.

It is important to note that the construction and arrangement of the elements of the systems and methods as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited herein. For example, elements shown as integrally formed may be constructed of multiple parts or elements. The position of elements may be reversed or otherwise varied, and the nature or number of discrete elements or positions may be altered or varied. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present invention. The order or sequence of any process, logical algorithm, or method steps may be varied or re-sequenced according to alternative embodiments. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A mixing drum system, comprising:
a mixing drum connected to a frame, wherein the mixing drum is configured to rotate about a first axis with respect to the frame;
a motor connected to the frame and having an output shaft, wherein the output shaft is configured to rotate about a second axis that is displaced from the first axis;
a first wheel connected to the output shaft of the motor, wherein the first wheel is configured to rotate about the second axis;
a second wheel connected to the mixing drum, wherein the second wheel is configured to rotate about the first axis; and
a belt wrapped around the first wheel and the second wheel;
wherein the motor is configured to rotate the first wheel, which drives the belt, and the belt is configured to rotate the second wheel, which rotates the mixing drum with respect to the frame.

2. The mixing drum system of claim 1, further comprising a belt tensioner configured to maintain tension in the belt.

3. The mixing drum system of claim 1, wherein the motor is a hydraulic motor.

4. The mixing drum system of claim 1, wherein the first wheel has a first wheel radius and the second wheel has a second wheel radius; and wherein the first wheel radius is smaller than the second wheel radius.

5. The mixing drum system of claim 1, wherein the belt is lined with fraction elements.

6. The mixing drum system of claim 5, wherein the first wheel and the second wheel have wheel traction elements that correspond with the belt traction elements.

7. The mixing drum system of claim 5, wherein the wheel traction elements and the belt traction elements are teeth.

8. The mixing drum system of claim 1, wherein the first wheel and the second wheel have guide walls that form a channel in each wheel, each channel is configured to receive the belt.

9. The mixing drum system of claim 1, wherein the second axis is generally parallel to the first axis.

10. A concrete mixing truck, comprising:
a chassis;
a cab connected to a front end of the chassis;
a mixing drum connected to the chassis, wherein the mixing drum is configured to rotate about a first axis with respect to the chassis; and
a mixing drum drive system, comprising:
a motor connected to the chassis and having an output shaft, wherein the output shaft is configured to rotate about a second axis that is displaced from the first axis;
a first wheel connected to the output shaft of the motor, wherein the first wheel is configured to rotate about the second axis;
a second wheel connected to the mixing drum, wherein the second wheel is configured to rotate about the first axis; and
a belt wrapped around the first wheel and the second wheel;
wherein the motor is configured to rotate the first wheel, which drives the belt, and the belt is configured to rotate the second wheel, which rotates the mixing drum with respect to the chassis.

11. The concrete mixing truck of claim 10, further comprising a chute configured to receive concrete from the mixing drum and guide the concrete away from the chassis.

12. The concrete mixing truck of claim 11, wherein the chute discharges the concrete at a rear end of the chassis.

13. The concrete mixing truck of claim 11, wherein the chute discharges the concrete at the front end of the chassis.

14. The concrete mixing truck of claim 10, further comprising:
an injection port configured for providing any of water, calcium chloride, or a concrete admixture into the mixing drum, and configured to not allow a content of mixing drum to leave the mixing drum;
wherein the injection port is located in a drum spindle of the mixing drum.

15. The concrete mixing truck of claim 14, wherein the drum spindle is connected to the mixing drum and is configured to rotate about the first axis, and wherein the second wheel is mounted around the drum spindle.

16. The concrete mixing truck of claim 10, wherein the second axis is generally parallel to the first axis.

17. A concrete mixing drum system, comprising:
a mixing drum connected to a chassis, the mixing drum includes a drum spindle that defines a first axis, the mixing drum further includes mixing fins, wherein the mixing drum is configured to rotate about the first axis with respect to the chassis;
a motor connected to the chassis and having an output shaft, wherein the output shaft is configured to rotate about a second axis that is offset and generally parallel to the first axis;
a first wheel connected to the output shaft of the motor, wherein the first wheel is configured to rotate about the second axis;
a second wheel connected to the mixing drum, wherein the second wheel is configured to rotate about the first axis, and wherein the second wheel is mounted around the drum spindle; and
a belt wrapped around the first wheel and the second wheel, wherein the belt has belt fraction elements;
wherein the motor is configured to rotate the first wheel, which drives the belt, and the belt is configured to rotate the second wheel, which rotates the mixing drum with respect to the chassis; and
wherein the first wheel and the second wheel include wheel traction elements that correspond to the belt traction elements.

18. The concrete mixing drum system of claim 17, wherein the chassis is part of a concrete mixing truck.

19. The concrete mixing drum system of claim 17, further comprising an injection port configured to provide at least one of water, calcium chloride, and a concrete admixture into the mixing drum and a valve configured prevent a content of mixing drum from leaving the mixing drum;
wherein the injection port is located in the drum spindle of the mixing drum.

20. The concrete mixing drum system of claim 17, wherein the first wheel has a first wheel radius and the second wheel has a second wheel radius; and wherein the first wheel radius is smaller than the second wheel radius.
